(19) United States
(12) Patent Application Publication
(10) Pub. No.: US 2002/0174246 A1
(43) Pub. Date: Nov. 21, 2002

(54) Centralized system for routing signals over an internet protocol network

(76) Inventors: Amos Tanay, Tel Aviv (IL); Jacob Tanay, Tel Aviv (IL); Yoram Avidan, Pardes Hana (IL)

Correspondence Address: FISH & NEAVE, 1251 AVENUE OF THE AMERICAS, 50TH FLOOR, NEW YORK, NY, 10020-1105, US

(21) Appl. No.: 09/768,521

(22) Filed: Jan. 24, 2001

Related U.S. Application Data
(60) Provisional application No. 60/232,505, filed on Sep. 13, 2000.

(51) Int. Cl. G06F 15/173

(52) U.S. Cl. 709/238

(57) ABSTRACT

A centralized system for routing signals over an Internet protocol network is provided. The system computes routing tables for routers in the network and distributes the tables to individual routers. In another aspect of the invention, a virtual signaling network is provided. The virtual signaling network preferably provides fault information and distributes instructions concerning the routers to the centralized system.

### BACKGROUND OF THE INVENTION

This invention relates to routing signals over an Internet protocol (IP) network. More particularly, this invention relates to optimizing the speed and accuracy of signals routed over the Internet as well as signals routed over smaller intranets.

The conventional routing mechanism in the Internet is based on the “per hop behavior” paradigm. In this paradigm, every router assembles data concerning the network topology and availability. Each router computes, independently of the other routers, its own routing table, which is the basis for its forwarding decisions. The single router has no knowledge of the overall network traffic load and performance. This method of determining signal routing is in line with the basic design goal of the Internet—Survivability. Furthermore, the Internet was not originally designed to provide any network services other than packet delivery. The packet delivery of the Internet was also not “guaranteed,”—i.e., no specific packet was guaranteed to arrive at the destination.

The present state of data communications converges toward an all IP networking. The IP protocol is becoming the standard network protocol. However, the IP protocol and the Internet routing paradigm are two separate entities. Thus, the adoption of the IP protocol does not necessitate the adoption of the present Internet routing paradigm. Furthermore, the networks which use the IP protocol are no longer extremely vulnerable, and do not value the design goal of survivability to the same degree as the original model network of the Internet. Rather, the networks which use IP protocol now include civilian, business-oriented networks which are required to offer and support a large set of services. These services may require information processing that is difficult to provide with convention the Internet routing paradigm. Thus, an improved IP protocol routing system is needed.

Therefore, it would be desirable to provide a centralized system that computes routing tables for routers in an IP protocol network.

It would also be desirable to provide a system that performs routing computations from a centralized location and removes the task of computing routes from the individual routers in an IP protocol network.

### SUMMARY OF THE INVENTION

It is an object of the invention to provide a centralized system that computes routing tables for routers in an IP protocol network.

It is also an object of the invention to provide a system that performs the routing computations from a centralized location and removes the task of computing routes from the individual routers in an IP protocol network.

A method and system for routing traffic on an Internet protocol communications network is provided. The method includes gathering network traffic statistics from the Internet protocol network, the statistics being based on a traffic load distribution of each of a plurality of routers, analyzing the traffic statistics, classifying the traffic into traffic classes, using a central system to build a network traffic matrix for routing the traffic based on the analyzing and the classifying, optimizing a plurality of routes between routers for the traffic based on the traffic matrix and distributing a routing table based on the optimizing from the system to the plurality of routers.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 is a detailed chart of a system according to the invention;

FIG. 2 is an exemplary flow chart of a method for routing traffic on an Internet protocol communications network according to the invention;

FIG. 3 is a flow chart which describes one method for calculating the efficiency of a joint flow distribution according to the invention;

FIG. 4 is a flow chart which describes one method of calculating the load distribution in the network according to the invention; and

FIG. 5 is a flow chart which describes the determination of the cost for each traffic model based on the load determined in FIG. 4 according to the invention.

### DETAILED DESCRIPTION OF THE INVENTION

Systems and methods for routing traffic on an Internet protocol network—i.e., a network using IP protocol are provided.

A system according to the invention preferably includes at least three basic modules: a network traffic statistics gathering system, a matrix formation and optimization system for classifying the traffic into classes and computing optimized routes for every traffic class according to the traffic statistics and a distribution system for distributing routing tables, including information concerning the optimized routes, to the individual routers. Each of these modules, and their interaction, is further described below.

The statistics gathering system preferably uses ingress traffic flow distributions at each router in the network to evaluate network traffic requirements. Egress traffic, or a combination of the two, i.e., ingress and egress traffic flow distributions, may also be used. Traffic may be measured in any known suitable fashion—e.g., beats per second, packets per second, packet length distribution, session length distribution. These statistics are used to form a computer-generated model of the network traffic requirements.

The optimizing system preferably uses the model, together with administration policy and goals, to classify the traffic into classes. Once the traffic is divided into classes, the optimizing system forms a traffic matrix based on the model and the classes. Thus, the optimizing system computes optimal routes for the traffic. By centralizing routing computation in the IP protocol network, as opposed to performing routing computation at each individual router, the process of optimization according to the invention obtains a more efficient quality performance for any given network. Furthermore, the quality performance of the network is improved because traffic distribution is used to influence routing table computations. The optimizing system may also preferably analyze the granularity—i.e., the particular size of each piece of traffic.

The third module is the distribution system. The distribution system preferably distributes the routing tables formed by the optimization system to each of the individual routers in the network. Thus, each of the individual routers route traffic based on the tables formed at the centralized optimization system.

This invention is neither limited to a particular number of modules nor is it limited to a particular modular configuration. Rather, the three modules described above are provided for purposes of illustration only.

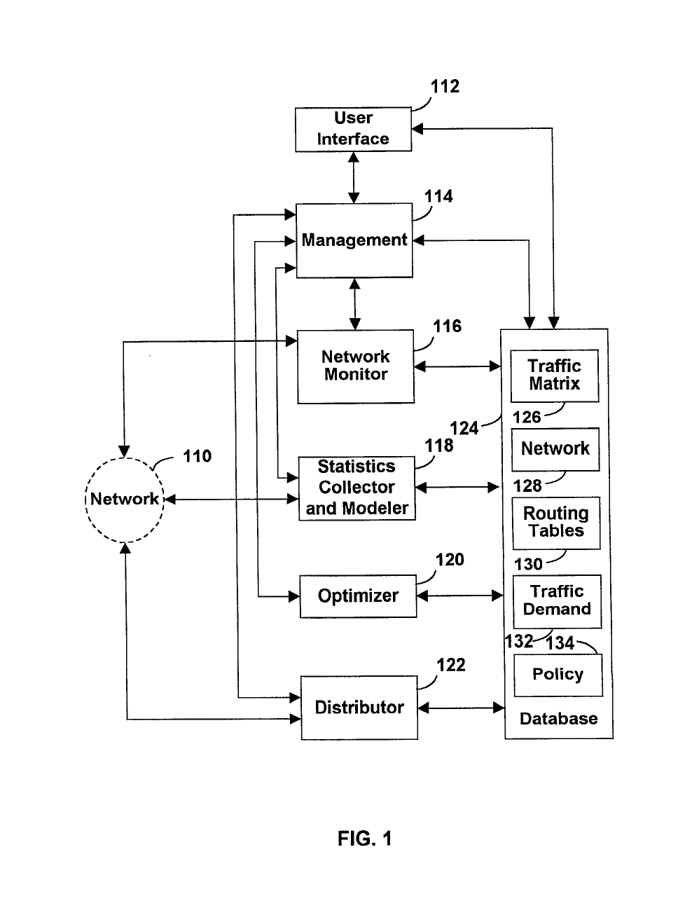

A detailed chart of a system 100 according to the invention is shown in FIG. 1. The system 100 includes an IP protocol network 110, a user interface 112, a management system 114, a network monitor 116, a statistics collector and modeler 118, an optimizer 120, a distributor 122, and a database 124.

Network 110 preferably interfaces with network monitor 116, statistics collector and modeler 118, and distributor 122. Management system 114 preferably interfaces with user interface 112, network monitor 116, statistics collector and modeler 118, optimizer 120 and distributor 122. Database 124 preferably interfaces with user interface 112, management system 114, network monitor 116, statistics collector and modeler 118, optimizer 120 and distributor 122. Database 124 preferably stores information relating to the traffic matrix 126, network information 128, routing tables 130, traffic demand 132 and policy 134.

Each of the components of system 100 operates as follows. (The components are explained approximately according to the order in which each component performs its respective operation in an exemplary system operation.)

Statistics collector and modeler 118 preferably polls the routers in network 110 and generates a statistical traffic model. The traffic model assigns flow distribution for each traffic class000* and time type—e.g., some general time

interval such as weekday a.m., weekday p.m, etc. The time type may also provide input as to predicted traffic flow—e.g., weedkday a.m. may be heavier traffic than weekend a.m. 000*The term Traffic Class is used herein as a generic term for indexing the classification of network traffic. The traffic is preferabley classified into traffic classes based on the information recovered from the ingress nodes of the routers. The following are examples of classifications for ingress traffic: 1) In conventional IP protocol routing: Traffic Class=(Source IP Address, Destination IP Address, Priority); 2) In MPLS [Multi-Protocol Label Switching]/MPλS [Multi-Protocol λ Swithching]: Traffic Class=(Forward Equivalence Class, label); 3) In optical routing, where ingress traffic is on wavelengths: Traffic Class=(Source IP Group, Destination IP Group, Wavelength).

Optimizer 120 receives the statistical traffic distribution models formed by statistic collector and modeler 118 from database 124. Optimizer 120 also receives time type information concerning the traffic because time type information has been encoded into the models. Optimizer 120 then, upon request from management system 114, preferably searches a certain number, which number may be pre-determined in quantity and scope, of possible routing schemes to select one that yields optimal traffic performance based on a pre-determined network quality performance measure, e.g., speed of delivery of highest priority traffic, overall speed of delivery for all traffic, etc. Thereafter, optimizer 120 transmits updated routing tables information 130 to database 124.

Then, distributor 122, upon request from management system 114, retrieves the updated routing tables 130 from database 124 and distributes the updated routing tables to the routers that require the new routing tables.

Network monitor 116 monitors network 110 for fault reports, i.e., indications that one or more of the routers are not operating properly. Once a fault has been discovered, network monitor 116 invokes an

interrupt sequence which informs the rest of system 100 that a fault is present in the system. Network 116 also acts to fix the fault once it has been discovered. The routers in network 110 are preferably pre-configured to transmit their fault reports to network monitor 116 via the virtual signaling network (an aspect of the present invention which will be discussed in depth below).

Management system 114 preferably coordinates the operation of the various components of system 100. Management system 114 also implements the control logic of system 100.

Database 124 preferably provides database services to all the components of system 100.

The user interface 112 enables an Administrator/Operator to monitor the system's operations and to manually trigger operations and processes in the system.

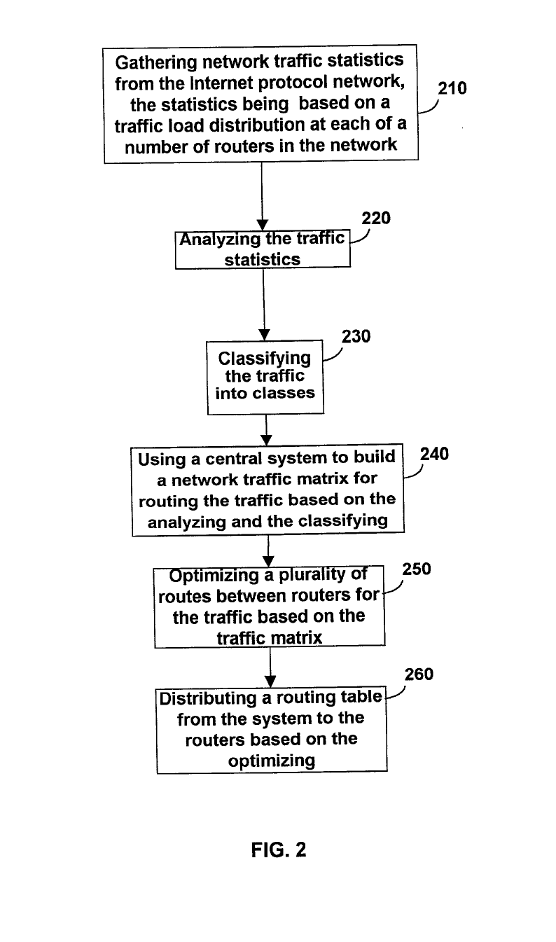

FIG. 2 shows an exemplary flow chart 200 of a method for routing traffic on an Internet protocol communications network according to the invention.

Box 210 shows a gathering of network traffic statistics from the Internet protocol network. The statistics are preferably based on a traffic load distribution of each of a number of routers in the network. Box 220 shows analyzing the traffic statistics. Box 230 shows a classifying of the traffic into traffic classes. Box 240 shows using a central system to build a network traffic matrix for routing the traffic based on the analyzing and the classifying. Box 250 shows optimizing a plurality of routes between routers for the traffic based on the traffic matrix and box 260 shows distributing a routing table based on the optimizing from the system to the plurality of routers.

An algorithm may be required to implement the purpose of the invention, i.e., to provide a system of centralized global routing scheme optimization based on the traffic matrix and administrative policy constraints and goals. This algorithm may be any standard search algorithm and an algorithm for calculating an overall network performance rank.

The algorithm evaluates the overall network performance in the IP protocol network 110. The following definition of an exemplary algorithm according to the invention analyzes various changes in the network functionality.

The following inputs may be used for the algorithm:

Network Structure (present topology of the network including nodes and associated load functions)

Traffic Class Priority (real number representing the relative importance of each traffic class)

User Priority (real number representing the relative importance of each user)

Router Quality/Load Function for Each Router (this function preferably associates a quality measure for each traffic flow through a node—this function determines potential for carrying increased information through a node)

These inputs may be used as determinants for an overall quality index calculation of a potential routing scheme.

An algorithm for an exemplary Quality Index calculation of a candidate Routing Scheme may be as follows:

Step 1:

Using a candidate route scheme, determine how much traffic will flow through each node. This determination is based on the network topology, the traffic matrix resident in the database and the exact determination of the path through which each traffic matrix entry would route data according to the candidate route scheme.

Step 2:

Combine the results of step I with the router load function to determine the overall load at each router. Then, sum the total for each traffic matrix entry based on its path according to the candidate routing scheme—i.e., the total load of each entry equals the sum of loads in the interfaces it is routed through. In an alternative embodiment, the total load for each path can be summed according to class of traffic.

Step 3:

For each entry in the traffic matrix, use the calculated load from step 2 as input to the cost function and obtain a per user cost. This per user cost reflects the relative quality each user would experience as a result of the candidate routing scheme. Sum these calculated costs to finalize the overall rank. The cost function corresponds to the resources and time required to process each piece of traffic from origination to destination.

As mentioned above, the flows can be measured in any suitable fashion. For example, the following formula may be used for the case where flows are statistical distributions. Each flow may be given by f(p) 0<=p<=1. The joint flow at each node (step 1 above) is obtained by taking the joint distribution of all the flows going through a node. The load function can be formulated for each statistical distribution as a set of integrals over the flow distribution, and the user cost function can be formed as an integral over a per user density function. Other suitable statistical strategies may also be used.

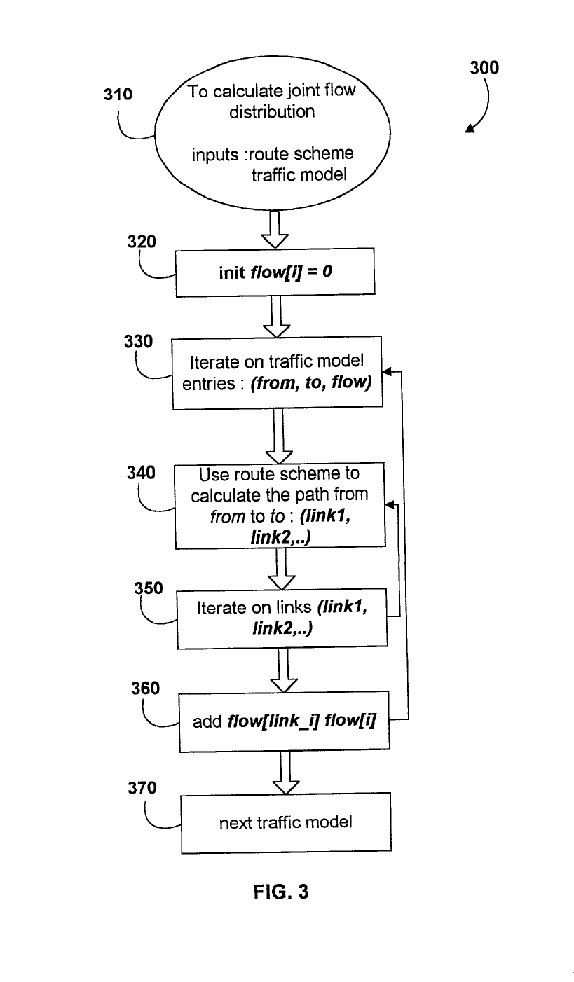

FIGS. 3-5 further illustrate one embodiment of an algorithm which may be implemented to process traffic according to the invention.

FIG. 3 is a flow chart 300 which describes one method according to the invention for calculating the efficiency of the joint flow distribution—i.e., the quantitative representation “flow[i]” of the route scheme (traffic distribution algorithm being tested) for a particular traffic model (location of the routers referred to above as traffic matrix entry). The required inputs, as shown in box 310, are the route scheme and the traffic model.

Box 320 indicates that a flow array variable (which describes, for each different traffic model, the sum of the flow between each router and any other given router) is initiated to zero.

Box 330 shows that each path from one particular router to another particular router is assigned a value that corresponds to the flow of data between these routers. This is done for each possible pair of routers.

Box 340 uses the route scheme to calculate the most efficient paths (link1, link2 . . . ) between each pair of routers based on the algorithm being tested as well as the possible paths determined in box 330.

Boxes 350 and 360 show that a running flow[i] is maintained that corresponds to the most efficient path between each of pair of routers determined in box 340.

The steps shown in boxes 350 and 360 are repeated until each link in the path is added to the flow[i].

Box 370 shows that the entire process, beginning with box 320 is repeated for each particular traffic model.

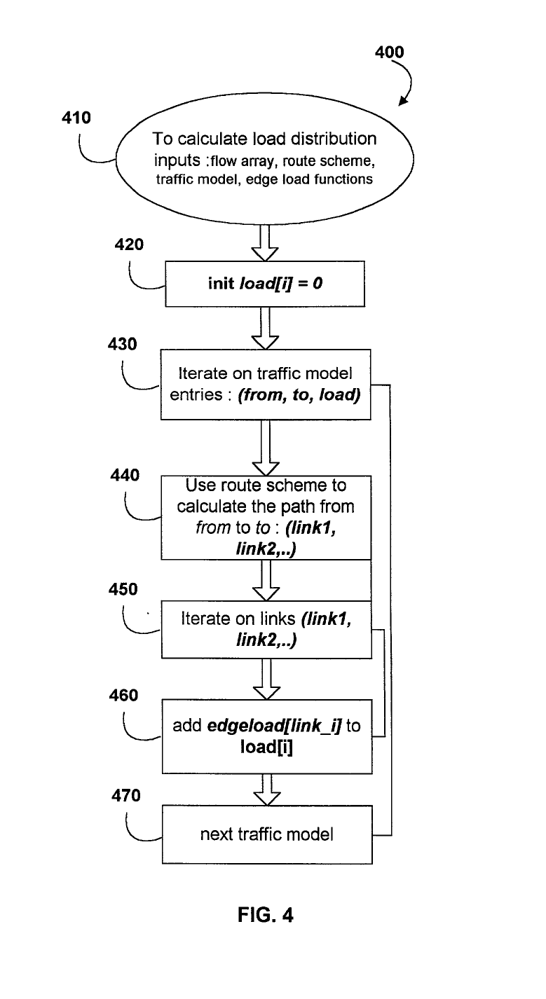

FIG. 4 shows a flow chart 400 which describes one method, according to the invention, of calculating the load distribution in the network—i.e., the amount of network resources required to support the flow as determined in flow chart 300.

The steps in boxes 410-470 substantially duplicate the steps shown in FIG. 3, boxes 310-370 with the single exception being that the derived quantity “load[i]”, which is derived by adding the individual edgeload of each path, represents the total load on each path—i.e., the network resources required to process the flow of traffic—as opposed to the flow of traffic itself.

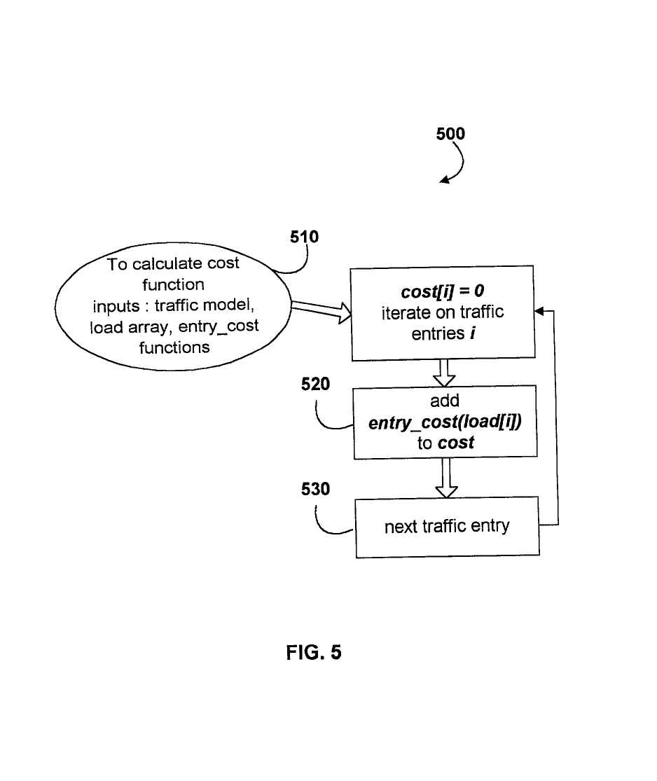

FIG. 5 is a flow chart 500 which describes the determination of the cost for each traffic model based on the load determined by flow chart 400.

Box 510 shows that the inputs to the cost determination are the traffic model, the load array (as determined by flow chart 400) the entry_cost (a given cost function).

Box 520 shows that cost array is initialized to zero for each traffic model entry.

Box 530 shows an iterative step wherein, for each load[i], the entry cost function is used to generate a cost value for that particular traffic model based on the load value.

Box 540 shows that this process is repeated for each traffic model.

Another aspect of the invention is related to the virtual signaling network. The virtual signaling network is a subset of the entire IP protocol network. Its task is to provide a fault tolerant network for the relatively critical information concerning network faults and routing tables distribution. The virtual signaling network preferably enables real time identification of faults, and solutions for the identified faults, in an IP protocol network.

A virtual signaling network according to the invention updates network monitor 116 concerning the system devices status. It includes a set of a small number of signaling IP addresses used by network monitor 116. For each of these addresses, a routing scheme defines a spanning tree, i.e., a particular web of routers within the system, to connect the particular address to network monitor 116. In this way, preferably every router in network 110 has a number of paths to monitor 116. This number is preferably equal to the number of signaling IP addresses. Though two paths from a single router to two signaling IP addresses may be through common routers, the goal of the virtual signaling network is to minimize the redundancy of such paths. This minimization preferably ensures that a single link failure may not block access between a particular router and the signaling IP addresses. It follows that each particular router has multiple paths to connect to network monitor 116. Thus, a virtual signaling network according to the invention is configurable to provide a limited set of IP addresses to receive fault information from individual routers along preferably unique paths, and then to process the fault information to monitor 116.

In this way every route from router to monitor 116 in the virtual signaling network is virtually an explicit route. Furthermore, each route is computed based on a global (and detailed) view of the network topology and traffic demand, and by taking into account supplementary requirements concerning this route.

Thus it is seen that a centralized system for coordinated network traffic on an IP protocol network has been provided. One skilled in the art will appreciate that the present invention can be practiced by other than the described embodiments, which are presented for purposes of illustration rather than of limitation, and the present invention is limited only by the claims which follow.

What is claimed is:

1. A method for routing traffic on an Internet protocol communications network, the method comprising:
gathering network traffic statistics from the Internet protocol network, the statistics being based on a traffic load distribution of each of a plurality of routers;
analyzing the traffic statistics;
classifying the traffic into traffic classes;
using a central system to build a network traffic matrix for routing the traffic based on the analyzing and the classifying;
optimizing a plurality of routes between the routers for the traffic based on the traffic matrix; and
distributing a routing table from the system to the plurality of routers based on the optimizing.

2. The method of claim 1, the gathering network traffic statistics comprising gathering ingress statistics.

3. The method of claim 1, the gathering network traffic statistics comprising gathering egress statistics.

4. The method of claim 1, the gathering network traffic statistics comprising gathering ingress statistics and egress statistics.

5. The method of claim 1, the analyzing comprising determining a granularity of the traffic.

6. The method of claim 1, further comprising monitoring the plurality of the routers within the network to determine a viability of each router.

7. The method of claim 6, further comprising distributing the routing tables based on the monitoring.

8. The method of claim 6, the monitoring comprising monitoring using a virtual signaling network.

9. The method of claim 1, wherein the gathering comprises gathering network packet traffic statistics.

10. The method of claim 1, wherein the gathering comprises gathering network optical traffic statistics.

11. A system that routes traffic on an Internet protocol communications network, the system comprising:
a statistics collector and modeler that collects network traffic statistics from the Internet protocol network;
an analyzer that analyzes the traffic statistics based on a traffic load distribution;
a classifier that classifies the traffic into traffic classes;
a central system that builds a network traffic matrix for routing the traffic based on information received from the analyzer and the classifier;
an optimizer that optimizes a plurality of routes between routers for the traffic based on the traffic matrix; and
a distributer that distributes a routing table from the system to the plurality of routers based on information received from the optimizer.

12. The system of claim 11, the collector further comprising a router ingress statistics collector.

13. The system of claim 11, the collector further comprising a router egress statistics collector.

14. The system of claim 11, the collector further comprising a router ingress and egress statistics collector.

15. The system of claim 11, the analyzer comprising a traffic granularity analyzer.

16. The system of claim 11, further comprising a monitor that monitors the plurality of the routers within the network to determine a viability of each router.

17. The system of claim 16, wherein the distributor distributes based on information received from the monitor.

18. The system of claim 16, the monitor comprising a virtual signaling network.

19. The system of claim 16, wherein the collector comprises a network packet traffic statistics collector.

20. The system of claim 16, wherein the collector comprises a network optical traffic statistics collector.

21. A virtual signaling Internet protocol monitoring network comprising:
a plurality of Internet protocol routers;
a network monitor; and
a plurality of signaling Internet protocol addresses, each Internet protocol address being coupled to the network monitor, each Internet protocol address providing a platform for each of the plurality of routers to provide a status report to the network monitor.

22. The network of claim 21, further comprising a plurality of unique paths from each router to the network monitor.
